(19) United States
(12) Patent Application Publication
(10) Pub. No.: US 2019/0228386 A1
(43) Pub. Date: Jul. 25, 2019

(54) RECORDING EVIDENCE OF ADDRESS/ACCOUNT ALLOCATIONS IN A DISTRIBUTED LEDGER

(71) Applicant: Xapo Holdings Limited, George Town (KY)

(72) Inventor: Carlos Maria Italo Rienzi Onnainty, Buenos Aires (AR)

(21) Appl. No.: 15/875,912

(22) Filed: Jan. 19, 2018

(51) Int. Cl. G06Q 20/06; H04L 9/06

(52) U.S. Cl. CPC G06Q 20/065; H04L 9/0643

(57) ABSTRACT

A system for storing in a blockchain that tracks a cryptocurrency information on the allocation of address having cryptocurrency to accounts having an account balance of the cryptocurrency is provided. The system generates an address/account allocation for each account that indicates addresses that have sufficient cryptocurrency to cover the account balance of the account. The system then generates a Merkle tree with leaf nodes for each account that includes the hash of the address/account allocation for the account. The system records a transaction in the blockchain that includes the root hash of the Merkle tree as evidence of the address/account allocation for an account. An account owner can use a purported address/account allocation to regenerate the root hash. If the regenerated root hash matches the root hash recorded in the blockchain, then the account owner has confirmed that the purported address/account allocation is the actual address/account allocation for the account.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key (or a hash of the public key referred to as an “address”) of the new owner, is digitally signed by the owner with the owner's private key to transfer ownership to the new owner, as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

The bitcoin system is an example of blockchain-based distributed ledger system. Other blockchain-based distributed ledger systems include Ethereum, Litecoin, Ripple, IOTA, and so on that each support a type of cryptocurrency. To enable more complex transactions than the bitcoin system can support, some distributed ledger systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide on which transactions to keep and which transactions to discard.

“Wallet” software has been developed to help users of the bitcoin system to generate and store their public and private keypairs, submit transactions to be recorded in the blockchain, and track their account balances by their addresses, which as described above is a hash of a public key of a public and private keypair of a user. For example, wallet software may list for each address the amount of unspent bitcoin associated with that address. Because a user's private key is needed when the user spends bitcoin that the user owns, users need to ensure that their private key is neither stolen nor lost. If their private key were stolen, then the thief could transfer the bitcoin assigned to the address of the corresponding public key to the thief's own address—meaning that the thief now owns the bitcoin. If a user's private key is lost, then the user could not spend the bitcoin assigned to the address of the corresponding public key—meaning the user has effectively lost the bitcoin. Wallet software can provide mechanisms to help ensure that the private keys are neither stolen or lost.

Because most commerce is conducted using fiat currency rather than cryptocurrency, exchange organizations have been established to exchange cryptocurrency to fiat currency, and vice versa. For example, to exchange bitcoin for fiat currency, the owner of the bitcoin would transfer an amount of bitcoin to the exchange organization. The exchange organization would then determine the current exchange rate and credit a bank account (e.g., or other account) of the user with an amount of fiat currency corresponding to the amount of bitcoin less a service fee. The user can then spend the fiat currency in their bank account.

At least one organization provides an additional service that helps ensure the security of the private keys and simplifies the process of exchanging cryptocurrency for fiat currency and conducting transactions with the fiat currency. For example, such an organization may purchase bitcoin that are assigned to a pool of its own addresses and allow its customers to purchase some of those bitcoins without actually transferring the bitcoin in the blockchain to the customers. The organization may maintain a database that, for each customer with an account, stores the amount of bitcoin of the pool that is owned by that customer in that account. The organization may provide its customers with debit cards that can be used to spend fiat currency. When a customer spends fiat currency using the debit card, the organization debits the customer's account an amount of bitcoin corresponding to the amount of fiat currency based on the current exchange rate. The organization may then exchange the amount of bitcoin of one of its addresses to fiat currency using an exchange organization. The organization may also delay the exchange when the organization believes that the exchange rate between bitcoin and the fiat currency will improve meaning that the organization can exchange the amount of bitcoin for an amount of fiat currency that is greater than the amount credited to the customer.

Such an organization may organize their addresses into a hot pool and a cold pool. The private keys corresponding to the addresses of the hot pool and the cold pool are stored in what is referred to as “hot storage” and “cold storage,” respectively. The hot storage is available in real time so that the private keys can be used to exchange cryptocurrency to fiat currency as needed to meet the anticipated demands of its customers. The cold storage is offline and is thus not available in real time. Although the hot storage and the cold storage are both very secure, the cold storage is even more secure as it is always offline reducing the possibility of being hacked.

### BRIEF DESCRIPTION OF THE DRAWINGS

FIG. 1A is an example hash tree generated as evidence of the account balances and the address/account allocations.

FIG. 1B illustrates a portion of the example hash tree needed to generate the root hash from a leaf node.

FIG. 2 is a flow diagram illustrating an overall process for generating evidence of account balances and address/account allocations in some embodiments.

FIG. 3 is a flow diagram that illustrates overall processing of confirming the allocation of addresses to an account in some embodiments.

FIG. 4 is a block diagram illustrating components of the CEG system in some embodiments.

FIG. 5 is a flow diagram that illustrates the processing of a record address/account allocation information of the CEG system in some embodiments.

FIG. 6 is a flow diagram that illustrates the processing of a generate address/account allocation component of the CEG system in some embodiments.

FIG. 7 is a flow diagram that illustrates the processing of a form address/account allocation component of the CEG system in some embodiments.

FIG. 8 is a flow diagram that illustrates the processing of a generate leaf node component of the CEG system in some embodiments.

FIG. 9 is a flow diagram that illustrates the processing of a generate accounts hash tree of the CEG system in some embodiments.

FIG. 10 is a flow diagram that illustrates the processing of a create hash tree component of the CEG system in some embodiments.

FIG. 11 is a flow diagram that illustrates the processing of a retrieve hashes component of the CEG system in some embodiments.

FIG. 12 is a flow diagram that illustrates the processing of the verify root hash component of the CEG system in some embodiments.

FIG. 13 is a flow diagram illustrating the processing of a hash component of the CEG system in some embodiments.

### DETAILED DESCRIPTION

A method and system are provided for storing in a blockchain, or more generally distributed ledger, information on balances of accounts of customers as evidence of each customer's balance in a currency. In some embodiments, a cryptocurrency evidence generation (“CEG”) system accesses an account database of account information that stores the current account balance of each account of a customer. The account database may be maintained by an organization that facilitates the exchanging of cryptocurrency and fiat currency of its customers. The current account balance of a customer specifies the amount of cryptocurrency owned by the customer. The cryptocurrency owned by the customers are recorded in a blockchain as being assigned to a pool of addresses of the organization. The pool maps each address of the organization to an address amount of cryptocurrency assigned to that address, the block height of the block in the blockchain that contains the last transaction of the address, the private key corresponding to the public key used to generate the address, and so on. Thus, the organization, rather than the individual customers, transfers cryptocurrency on behalf of the customers by recording transactions in the blockchain. For example, the organization may record a transaction to transfer an amount to a cryptocurrency from an address of the organization to the address of an exchange to cover a payment in fiat currency from the account of a customer.

The CEG system may periodically generate an evidence of the account balances of the account and evidence that the organization has sufficient cryptocurrency associated with the addresses of its pool of addresses to cover the account balances. The evidence of the allocation of addresses to an account is referred to as an “address/account allocation.” To generate the address/account allocation for a customer's account, the CEG system retrieves the account balance of the account from the account database. For example, the account balance for a customer may be 10 bitcoins. The CEG system allocates to the account one or more addresses from a pool of addresses with address balances to cover the account balance. To allocate an address, the CEG system identifies an address whose address balance has not been fully allocated to accounts. For example, if the address balance of a first address is 100 bitcoins and 97 bitcoins have already been allocated to accounts, then the first address has 3 bitcoins that have not been allocated to an account, referred to as the remaining address balance. Thus, the CEG system may allocate the first address to the account leaving a remaining account balance of 7 bitcoins (i.e., 10 bitcoins−3 bitcoins). The first address would then have its address balance fully allocated to accounts that is its remaining address balance is 0. The CEG system then allocates a second address to the account. If the second address has a remaining address balance of at least 7 bitcoins, then the second address is allocated to the account to cover the account balance. The address/account allocation for the account may include the account balance of 10, the first address and allocated amount of 3, and the second address and allocated amount of 7. The CEG system performs a similar allocation for each account.

After the address/account allocation for the accounts has been generate, the CEG system generates hash tree (e.g., Merkle tree), which is a binary tree, as confirmation of the address/account allocations for the accounts. To generate the hash tree, the CEG system generates an account hash for each account based on the address/account allocation for the account. The CEG system may generate an account hash for an account by first combining the account identifier, the account balance, the addresses allocated to the account, the amount of bitcoins allocated from each address to the account, and so on. The CEG system then generates an account hash for an account from the combination for the account. The CEG system then creates a leaf node of the hash tree for each account. Each leaf node for an account contains the account hash for the account and may include the account balance of the account. The CEG system then forms a hash tree from the leaf nodes so that each non-leaf node contains a hash of the hashes of its child nodes and contains the sum of the balances of its child nodes. The root node of the hash tree thus contains a hash generated based on all the account hashes and contains the sum of all the account balances.

The CEG system then records the “root hash” of the root node of hash tree in the blockchain. For example, the CEG system may record the root hash in the bitcoin blockchain by recording a transaction that inputs the bitcoin of a designated address and outputs all that bitcoin (except possibly for a service fee) to the designated address. The recorded transaction includes a script for an output that includes the root hash. Thus, the transaction recorded in the bitcoin blockchain is evidence of the allocation of addresses to the accounts that were used to generate the hashes of the leaf node. The CEG system may generate a hash tree daily to reflect that allocation of addresses to accounts as the number of account and account balances may change over time. In some embodiments, the hash tree may be a Merkle tree. Traditionally, the leaf nodes of a Merkle tree are the sets of data used to generate the lowest level hashes from which the other hashes of the Merkle tree are derived. For example, the address/account allocations of the accounts would be the leaf nodes of a Merkle tree. As used herein, however, the address/account allocations are not considered to be nodes of the hash tree or Merkle tree. Thus, a hash tree includes only nodes that contain hashes with the leaf nodes containing the hashes of the address/account allocations.

In some embodiments, the organization may publish the designated address so that various parties such as its customers and regulatory authorities can retrieve the root hashes. The CEG system may provide to each customer the address/account allocation for the customer and the hashes of nodes of the hash tree that are sufficient for the customer to ensure that provided address/account allocation is accurate as represented by the root hash. The CEG system may also provide to a regulatory authority the address/account allocations for all accounts so that the regulatory authority can confirm that addresses have sufficient cryptocurrency to cover the account balances and that the addresses are controlled by the organization. To confirm that an address is controlled by the organization, the regulatory authority may request the organization to record a transaction that transfers a specified amount of cryptocurrency from the address to the address. For example, the specified amount may a randomly generated small amount of bitcoin such as 0.000484765 bitcoin. If such a transaction is recorded, then the regulatory authority knows that the address is controlled by the organization. In some embodiments, the CEG system may additionally store the root hash in other locations to facilitate rapid retrieval. For example, the root hash may be stored (e.g., cached) on satellite. The root hash can be retrieved from the satellite and then if the root hash indicates that the address/account allocation is correct, then the root hash can then be retrieved from the blockchain to verify that the root hash store in the satellite was the correct root hash.

In some embodiments, the pool of addresses may be divided into a hot pool and a cold pool. In such a case, the CEG system may first allocate addresses from the hot pool and then allocate addresses from the cold pool. In certain situations, the hot pool and cold pool may not have sufficient amount of cryptocurrency to cover the account balances of all the accounts. For example, the organization may receive a request from a customer to exchange fiat currency for cryptocurrency. In such a case, the organization may credit the customer's account an amount of the cryptocurrency based on the current exchange rate, but delay the exchange of the fiat currency for cryptocurrency in anticipation that the exchange rate may improve until later. The exchange rate improves in the sense that the cost of the cryptocurrency in terms of the fiat currency decreases. Thus, the organization can exchange the fiat currency for more than cryptocurrency that was credited to the customer's account. In such a case, the hot pool and cold pool may not have control enough cryptocurrency to cover the customer's account balance. To factor in the possibility of such a shortfall, the organization may maintain a reserve pool of addresses that are owned and controlled by the organization. If the hot pool and the cold pool are not sufficient to cover the account balances, then the CEG system allocates addresses from the reserve pool after the hot pool and cold pool have been fully allocated. The CEG system may store the addresses of the reserve pool in cold storage as they may be needed only when generating the address/account allocations and when the hot pool and the cold pool are not sufficient to cover the account balances.

In some embodiments, when generating an account hash for an account, the CEG system may further base the account hash on a randomly generated customer-specific nonce. The use of a randomly generated customer-specific nonce helps ensure that the account hash cannot not be generated without the customer-specific nonce. The organization may provide the customer-specific nonce to the customer so that the customer can confirm that the root hash was derived from the address/account allocation for an account of the customer as published by the organization and thus that the address/account allocation is the actual allocation. Another party could not confirm whether the root hash was derived from the address/account allocation without the customer-specific nonce.

Although described primarily in the context of providing evidence of balances of accounts of cryptocurrencies, the CEG system may also be used to provide evidence of accounts for other types of assets, such as fiat currencies, precious metals, commodities, and so on, that can be held on behalf of customers. For example, a bank may employ the CEG system to provide evidence of the account balances of its customers. To provide the evidence, the CEG system of the bank may generate on a daily basis a leaf node for each customer that identifies the bank account and its balance. The CEG system then generates a hash tree and records the root hash in a blockchain. A customer can verify their account balance for any given day by retrieving their account information from the bank and verifying that it was used to generate a hash tree with the recorded root hash for that day. A bank may also use the CEG system to provide evidence to regulatory authorities that the bank has sufficient liquid assets to meet regulatory requirements. For example, a bank may be required to have a reserve of a certain amount of cash, a certain amount of highly liquid assets, and a certain amount of moderately liquid assets that are based on a percent of the total of the account balances. In such a case, the CEG system may generate a leaf node for each bank account that identifies the amount of cash, the highly liquid assets and their amounts, and the moderately liquid assets and their amounts that are allocated to the bank account. Each bank account may be allocated the cash and assets in the same percentage based on regulatory requirements. For example, if the bank is required to maintain a liquid reserve of 50% of the account balances, the CEG system may allocate to each bank account cash, highly liquid assets, and moderately liquid assets based on 5%, 15%, and 30%, respectively, of the account balance. Such allocations are similar to those for the different addresses of the hot pool and the cold pool for cryptocurrencies. A regulatory authority can then check the allocations and confirm that they were used to generate the recorded root hash.

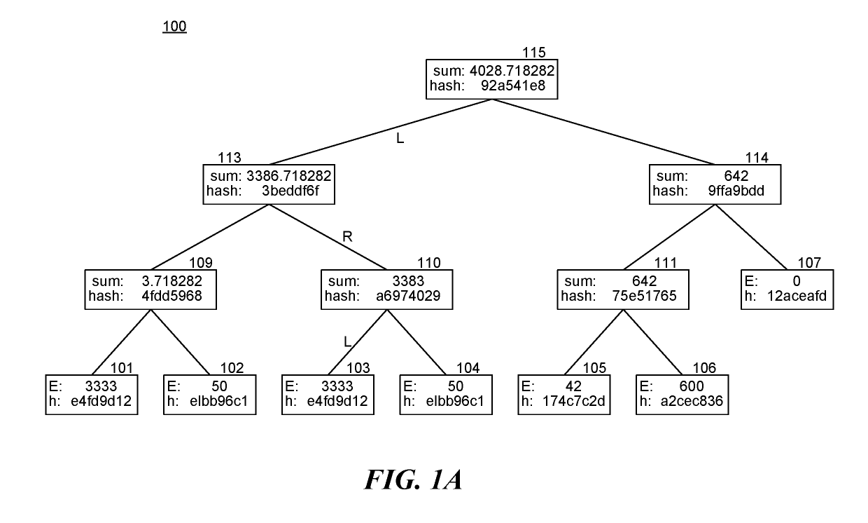

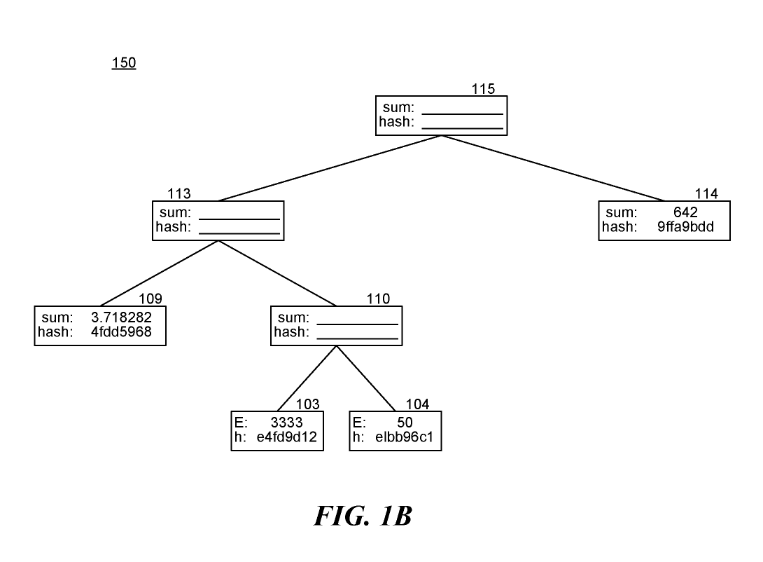

FIG. 1A is an example hash tree generated as evidence of the account balances and the address/account allocations. A hash tree 100 includes leaf nodes 101-107, interior nodes 109-111 and 113-114, and root node 115. Each leaf node contains the account hash of the account balance of an account and the address/account allocation of the account. For example, leaf node 103 contains the account balance of 3333 bitcoins and account hash of “e4fd9d12.” Interior node 110 includes a balance of 3383 that is the sum of the account balances of 3333 and 50 of leaf nodes 103 and 104, respectively, and a hash of “a6974029” generated from the account hashes of leaf nodes 103 and 104. The root node 115 includes a balance of 4028.718282 that is the sum of the account balances of leaf nods 101-107 and a root hash of “92a541e8” generated from the hashes of nodes 113 and 114. Alternatively, the hash of a non-leaf node may be a hash of the hashes of its child nodes and of the balances of its child nodes. For example, the hash for interior node 110 may be the hash of the string: “e4fd9d12”+“elbb96c1”+“3333”+“50.”

A leaf node for an account can be identified by a path from the root node to the leaf node. A path specifies the left (“L”) or right (“R”) branch taken for each node along the path. For example, the path from the root node to the leaf node 103 is through nodes 115, 113, 110, and 103 and may be identified by “LRL.” The first “L” identifies the left branch from node 115 to node 113, the “R” identifies the right branch from node 113 to node 110, and the second “L” identifies the left branch from node 110 to node 103.

In some embodiments, to verify that the address/account allocation for an account is the actual allocation by the organization, a party would need the address/account allocation, path to the leaf node for the account, and hashes of sibling nodes to the nodes that are along the path. Continuing with the example, a party who is to verify the address/account allocation represented by leaf node 103 would need the root hash (e.g., retrieved from the blockchain), the hash tree, the path to the leaf node 103, the hashes of the sibling nodes, and the address/account allocation. The sibling nodes are nodes 114, 109, and 104 as nodes 113 and 114 are siblings, nodes 110 and 109 are siblings, and nodes 103 and 104 are siblings. The party would then generate a hash of the address/account allocation, follow the path to leaf node 103, and compare the generated hash to the hash of leaf node 103. If they match, then the party knows that the hash of leaf node 103 was derived from the address/account allocation. The party, however, would not yet know whether the root hash was derived from the hash of leaf node 103. To confirm that the root hash has was derived from the hash of leaf node 103, the party would generate a hash of the hash of leaf node 103 and the hash of its sibling node 104. The party continues in a similar manner until the party generates a root hash. FIG. 1B illustrates a portion of the example hash tree needed to generate the root hash from a leaf node. The portion 150 of the hash tree indicates that the hashes are sibling nodes 114, 109, and 104 are provided and leaf node 103 would be provided or regenerated. The sums and the hashes of blank nodes 115, 113, and 110 are generated to generate the root hash, which is the hash of node 115. If the generated root hash matches the root hash stored in the blockchain, then the party knows that the address/account allocation for the account is represented by the root hash. A regulatory authority who has access to the address/account allocation for each account could in addition to verifying the actual address/account allocations also ensure that no more than address balance of an address was allocated to the accounts. For example, if an address has 100 bitcoins and 90 bitcoins of the address were allocated to one account and 50 bitcoins of the address were allocated to another account, the regulatory authority would know that the address had been over-allocates as 140 bitcoins were allocated from an address that has only 100 bitcoins.

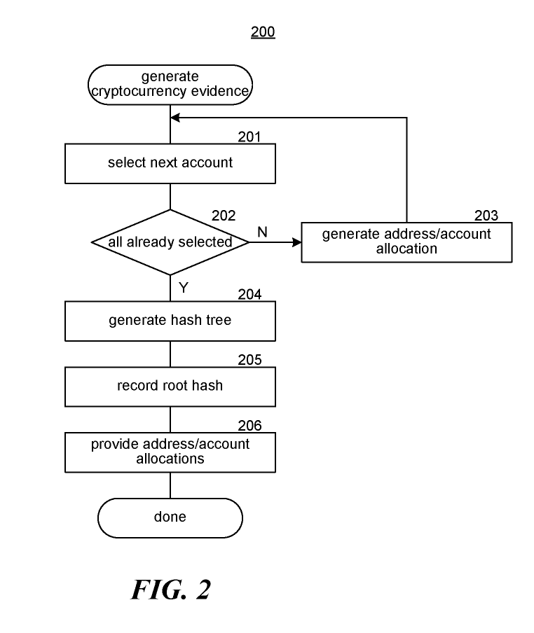

FIG. 2 is a flow diagram illustrating an overall process for generating evidence of account balances and address/account allocations in some embodiments. A generate cryptocurrency the evidence component 200 is invoked to generate address/account allocations and record a root hash of a corresponding hash tree in a distributed ledger. In block 201, the component selects a next account. In decision block 202, if all the accounts have already been selected, then the component continues at block 204, else the component continues at block 203. In block 203, the component generates an address/account allocation for the selected account and loops to block 201 to select the next account. In block 204, the component generates a hash tree based on the generated address/account allocations. In block 205, the component records the root hash of the root node of the hash tree in a distributed ledger. In block 206, the component provides the address/account allocations so that parties can verify that the root hash is derived from the address/account allocations. The component then completes. Although not illustrated, the component may provide the hash tree, paths to leaf nodes, hashes of sibling nodes, and so on to facilitate the verification.

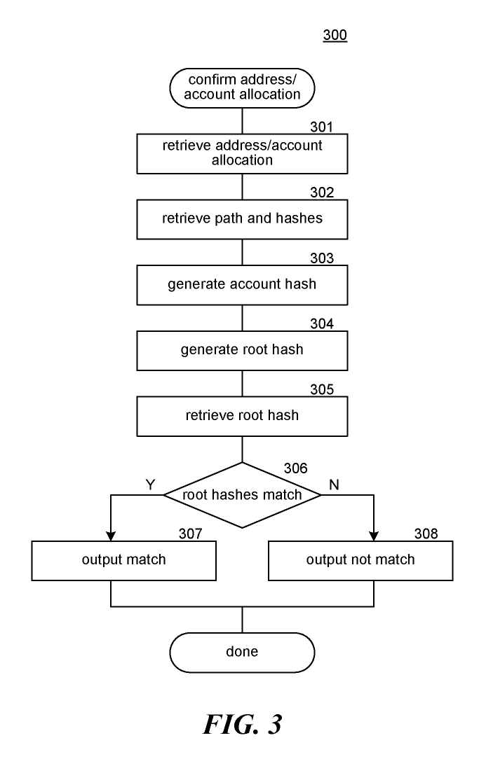

FIG. 3 is a flow diagram that illustrates overall processing of confirming the allocation of addresses to an account in some embodiments. A confirm address/allocation account component 300 is invoked to confirm the allocation of addresses to an account. An owner of an account may use the component to confirm their account balance and that sufficient cryptocurrency of one or more addresses has been allocated to the account to cover their account balance. In block 301, the component retrieves an address/account allocation for the account. In block 302, the component retrieves the path within a hash tree to the leaf node that stores the account hash of the account and retrieves the hashes of sibling nodes along the path. In block 303, the component generates an account hash based on the address/account allocation for the account. In block 304, the component generates hashes of the hash tree that includes a root hash. In block 305, the component retrieves the root hash that is recorded in the distributed ledger. In decision block 306, if the root hashes match, then the component continues at block 307, else the component continues at block 308. In block 307, the component outputs an indication that the hashes match and then completes. In block 308, the component outputs an indication that the hashes do not match and then completes.

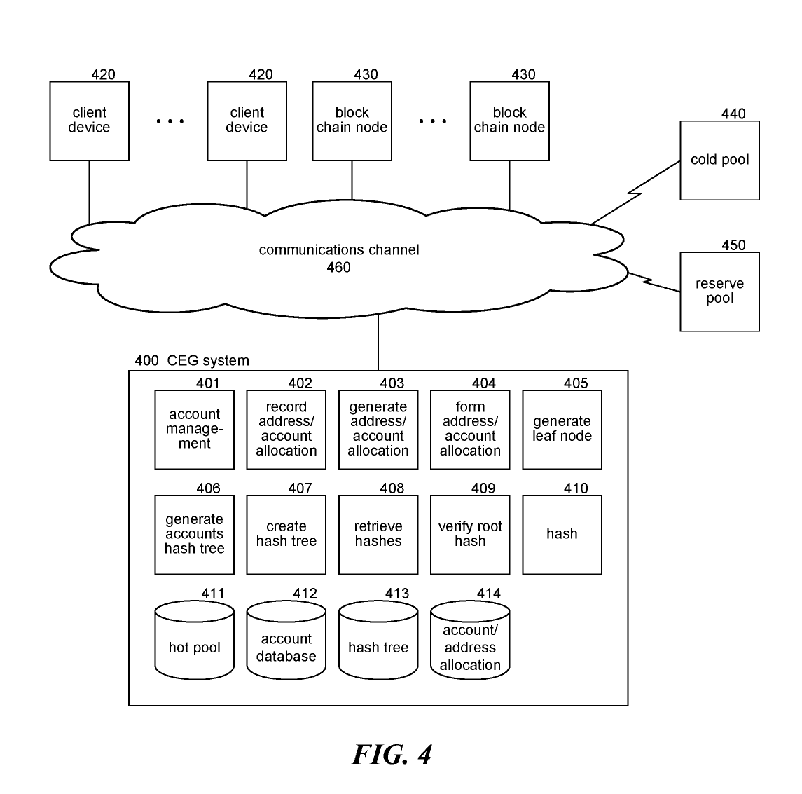

FIG. 4 is a block diagram illustrating components of the CEG system in some embodiments. The CEG system 400 may include an account management component 401, a record address/account allocation information component 402, a generate address/account allocation component 403, a form address/account allocation component 404, a generate leaf node component 405, a generate accounts hash tree component 406, a create hash tree component 407, a retrieve hashes component 408, a verify root hash component 409, and a hash component 410. The CEG system may also include a hot pool store 411, an account database store 412, a hash tree store 413, and an address/account allocation store 414. The account management component coordinates the overall management of the accounts such as creating accounts, adjusting account balances, deleting accounts, and so on. The record address/account allocation information component controls the overall process of recording in a distributed ledger a root hash of a hash tree of hashes derived from the address/account allocations. The generate address/account allocation component generates the address/account allocation for an account. The generate leaf node component generates a leaf node of the hash tree for each address/account allocation. The generate accounts hash tree component generates a region hash subtree for various regions (e.g., North America, South America, and Europe) and combines the region hash subtrees to form a single hash tree with a root node that stores the root hash for the address/account allocations of all regions. The create hash tree component is passed leaf nodes and generates a hash tree from the hashes of the leaf nodes. The retrieve hashes component retrieves from a hash tree the sibling hashes of sibling nodes on the path from the root node to a leaf node. The verify root hash component generates the account hash for an account based on the address/allocation information for the account, generates a root hash derived from that account hash, and verifies that the root hash matches the root hash recorded in the distributed ledger. The hash component generates a root hash based on the address/allocation information for an account. The hot pool stores the addresses, public and private key pairs, and the address balance of each address of the hot pool. The account database store stores a record for each account that includes an account identifier, an account owner, an account balance, a currency (e.g., bitcoin or dollars) of the account, and so on. The account database store may also store information on the activity of each account such as purchasing additional cryptocurrency, exchanging cryptocurrency for fiat currency, and so on. The hash tree store stores the hash trees generated by the CEG system. The address/account allocation store stores the address/account allocations generated, for example, daily for each account. The CEG system is connected to client devices 420, blockchain nodes 430, a cold pool store 440, and a reserve pool store 450 via communications channel 460. The client devices represent devices of customers, regulatory authorities, and so on that access or receive information from the CEG system. The blockchain nodes manage the blocks of the blockchain. The management of the blockchain may include receiving transactions, generating nonces for blocks (i.e., mining), verifying transactions, and so on. The cold pool store and the reserve pool store store the addresses, public and private key pairs, and the address balance of each address of the cold pool and reserve pool, respectively.

The computing systems (e.g., nodes) on which the CEG system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the CEG system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The CEG system may be described in the general context of computer-executable instructions, such as program modules and components, executed by one or more computers, processors, or other devices. Generally, program modules or components include routines, programs, objects, data structures, and so on that perform tasks or implement data types of the CEG system. Typically, the functionality of the program modules may be combined or distributed as desired in various examples. Aspects of the CEG system may be implemented in hardware using, for example, an application-specific integrated circuit (“ASIC”) or field programmable gate array (“FPGA”).

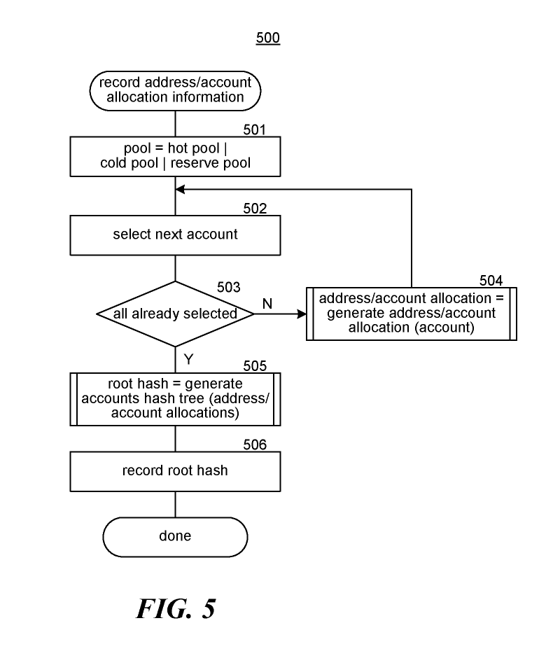

FIG. 5 is a flow diagram that illustrates the processing of a record address/account allocation information of the CEG system in some embodiments. A record address/account allocation information component 500 is invoked to record in a blockchain a root hash generated based on the address/account allocations of the accounts. In block 501, the component generates a combined pool of the information of the hot pool, followed by the information of the cold pool, and then the information of the reserve pool. The combined pool may be considered a queue in which the information for a single address is popped from the top of the queue at a time. In block 502, the component selects the next account. In decision block 503, if all the accounts have already been selected, then the component continues at block 505, else the component continues at block 504. In block 504, the component invokes a generate address/account allocation component passing an indication of the selected account to generate an address/account allocation for the selected account. The component then loops to block 502 to select the next account. In block 505, the component invokes a generate accounts hash tree component passing indication of the address/account allocations to generate a hash tree and return the root hash of the hash tree. In block 506, the component records the root hash in the blockchain by recording a transaction with an output having a script that includes the root hash. The component then completes.

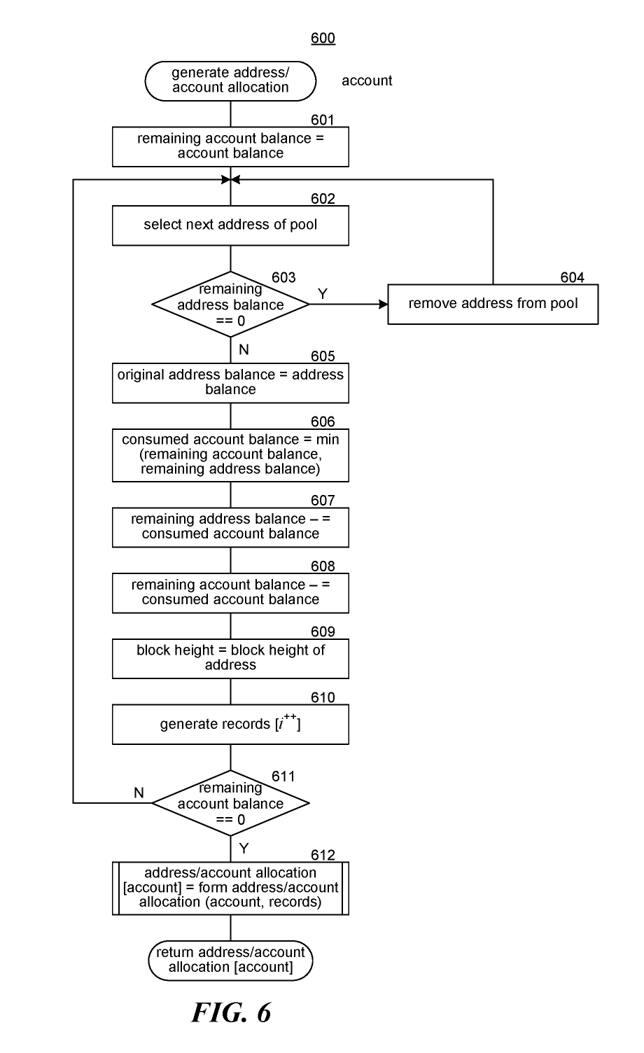

FIG. 6 is a flow diagram that illustrates the processing of a generate address/account allocation component of the CEG system in some embodiments. A generate address/account allocation component 600 is passed an account and generates address/account allocation information for that account. In block 601, the component sets a remaining account balance to the account balance of the account. The remaining account balance tracks the balance of the account that has not yet been allocated an address. In block 602, the component selects the next address of the combined pool. The component maintains a remaining address balance for the selected address to track the portion of its address balance that has not yet been allocated to an account. When an address is first selected, its remaining address balance is initialized to its address balance. In decision block 603, if the remaining address balance is equal to zero, then the component continues at block 604, else the component continues at block 605. In block 604, the component removes the address from the combined pool because its address balance has been fully allocated to accounts and then loops to block 602 to select the next address of the combined pool. In block 605, the component sets an original address balance to the address balance of the selected address. The original address balance of an address is stored in the address/account allocation of each account to which the address is allocated. In block 606, the component sets a consumed account balance to the amount of the remaining address balance of the selected address to be allocated to the account. The component sets the consumed account balance to the minimum of the remaining account balance and the remaining address balance. In block 607, the component decrements the remaining address balance by the consumed account balance. In block 608, the component decrements the remaining account balance by the consumed account balance. In block 609, the component sets the block height to the block height of the last block containing a transaction for the address. In block 610, the component generates a record for the allocation of the address to the account and increments a pointer to the next record. In decision block 611, if the remaining account balance equals zero, then the component continues at block 612, else the component loops at block 602 to select the next address of the combined pool. In block 612, the component invokes a form address/account allocation component to a generate the address/account allocation for the selected account based on the addresses allocated to the account. The component then returns the address/account allocation.

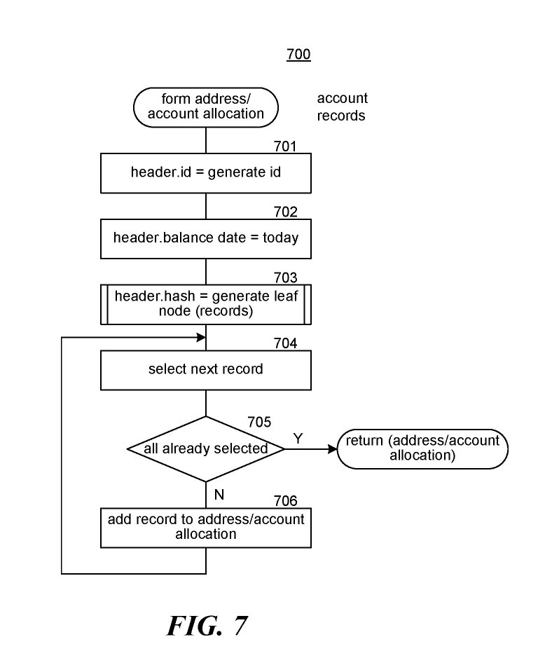

FIG. 7 is a flow diagram that illustrates the processing of a form address/account allocation component of the CEG system in some embodiments. A form address/account allocation component 700 is passed an indication of an account and records an indication of the addresses allocated to the account and forms an address/account allocation record. In block 701, the component sets an identifier field of the header portion of the allocation record to a generated unique identifier. In block 702, the component sets a balance date field of the header portion to today's date. In block 702, the component sets a hash field of the header portion to the hash of the records indicating the allocation of addresses by invoking a generate leaf node component. In blocks 705, the component selects the next record indicating the allocation of an address to the account. In decision block 704, if all such records have already been selected, then the component returns the address/account allocation record, else the component continues at block 706. In block 706, the component adds the selected record to the address/account allocation record and then loops to block 704 to select the next record.

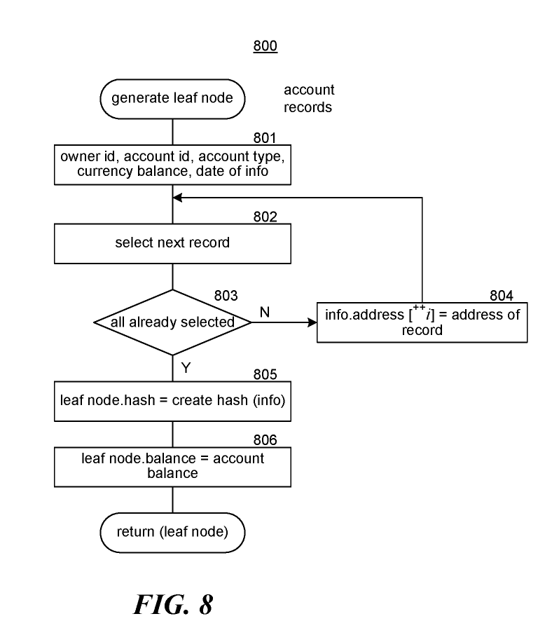

FIG. 8 is a flow diagram that illustrates the processing of a generate leaf node component of the CEG system in some embodiments. A generate leaf node component 800 is invoked passing an indication of an account and the records indicating the allocation of addresses to the account. In block 801, the component initializes various fields of an information data structure that is used to generate the hash for the leaf node. The fields include an owner identifier, an account identifier, an account type (e.g., individual or institution), currency, account balance, date, and so on. In block 802, the component selects the next record. In decision block 803, if all the records have already been selected, then the component continues at block 805, else the component continues at block 804. In block 804, the component sets the next entry in an array of the information data structure to contain the address and the consumed account balance of the selected record. The entry may also contain the original address balance, the remaining address balance, and the remaining account balance. The component then loops to block 802 to select next record. In block 805, the component sets a hash field of the leaf node to the hash of the information data structure by invoking a create hash component. In block 806, the component sets a balance field of the leaf node to the account balance. The component then returns the leaf node.

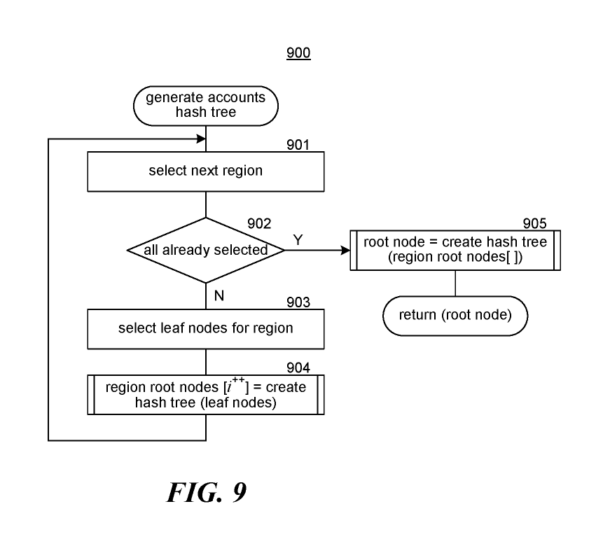

FIG. 9 is a flow diagram that illustrates the processing of a generate accounts hash tree of the CEG system in some embodiments. A generate accounts hash tree component 900 is invoked to generate a hash tree that includes a hash subtree for each region. In block 901, the component selects the next region. In decision block 902, if all the regions have already been selected, then the component continues at block 905, else the component continues at block 903. In block 903, the component selects the leaf nodes for the region. In block 904, the component invokes a create hash tree component passing an indication of the selected leaf nodes to generate a hash subtree for the region. The component then stores the region root node, which is the root node of the region hash subtree, in an array of region root nodes. The component then loops to block 901 to select the next region. In block 905, the component invokes the create hash tree component passing the region root nodes to generate a hash tree that includes the region hash subtrees. The create hash tree component returns the root node of the hash tree. The component then returns the root node of the hash tree.

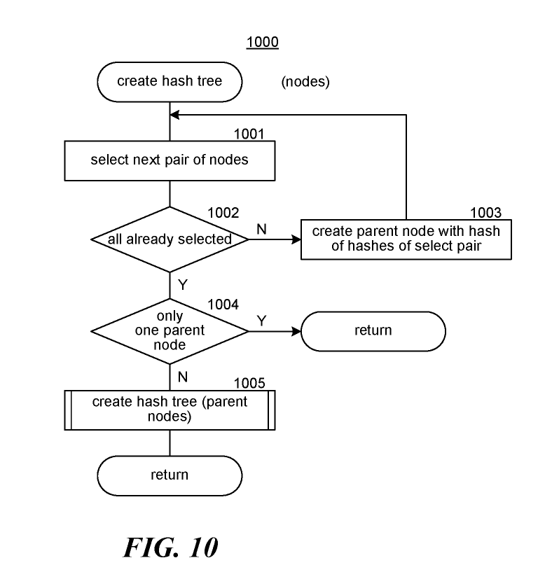

FIG. 10 is a flow diagram that illustrates the processing of a create hash tree component of the CEG system in some embodiments. A create hash tree component 1000 is invoked passing nodes to generate a hash tree with the passed nodes as the leaf nodes of the hash tree. In block 1001, the component selects a next pair of nodes. In decision block 1002, if all the nodes have already been selected, then the component continues at block 1004, else the component continues at block 1003. In block 1003, the component creates a parent node with a balance that is the sum of the balances of the selected pair and with the hash that is a hash of the hashes of the selected pair. The component then loops to block 1001 to select the next pair of nodes. In decision block 1004, if there is only one parent node, then the component returns, else the component continues at block 1005. In block 1005, the component recursively invokes the create hash tree component passing an indication of the parent nodes to generate higher level nodes of the hash tree. The component then returns.

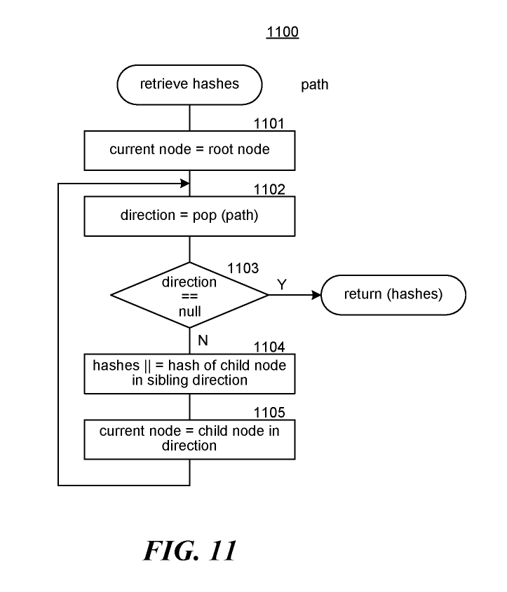

FIG. 11 is a flow diagram that illustrates the processing of a retrieve hashes component of the CEG system in some embodiments. A retrieve hashes component 1100 is passed a path to a leaf node and retrieves the hashes of sibling nodes along the path for use in regenerating the root hash of the hash tree. In block 1101, the component sets the current node to the root node of the hash tree. In block 1102, the component sets the direction to the first direction in the path and removes the first direction from the path. In block 1103, if the direction is null because the path is empty, then the component returns an indication of the hashes, else the component continues at block 1104. In block 1104, the component adds to a queue of hashes the hash of the sibling node, which is the child node of the current node in the opposite of the direction. In block 1105, the component sets the current node to the child node in the direction and then loops to block 1102 to process the next direction in the path.

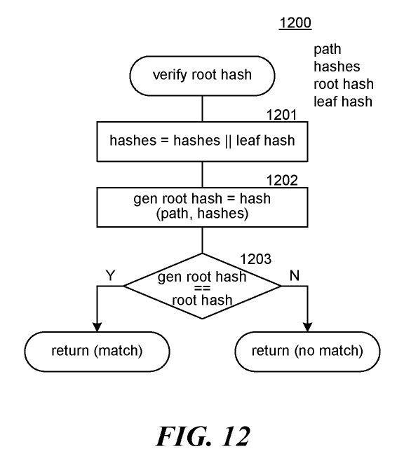

FIG. 12 is a flow diagram that illustrates the processing of the verify root hash component of the CEG system in some embodiments. A verify root hash component 1200 is invoked to verify that the hash of the leaf node can be used to generate the root hash of the hash tree. The component is passed an indication of the path to the leaf node, the hashes of the sibling nodes along the path, the root hash, and the leaf hash. In block 1201, the component concatenate the leaf hash to the end of the hashes. In block 1202, the component invokes a hash component passing indication of the path and the hashes to generate a root hash based on the path and the hashes. In decision block 1203, if the generated root hash matches the passed root hash, then the component returns an indication of a match, else the component returns an indication of no match.

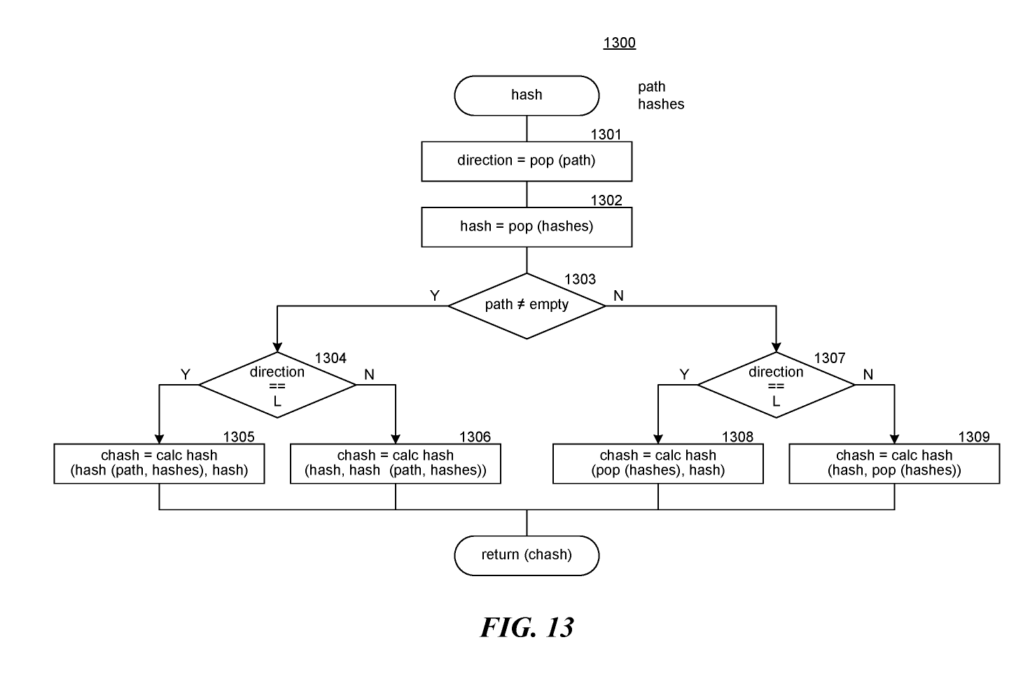

FIG. 13 is a flow diagram illustrating the processing of a hash component of the CEG system in some embodiments. A hash component 1300 is invoked passing an indication of a path and hashes and generates a generated root hash based on the path and hashes. In block 1301, the component pops the top direction from the path. In block 1302, the component pops the top hash from the hashes. In decision block 1303, if the path is not empty, then the component continues at block 1304 to generate a hash based on the hashes of non-leaf nodes, else the component continues at block 1307 to generate a hash based on the hashes of leaf nodes. In decision block 1304, if the direction is left, then the component continues at block 1305, else the component continues at block 1306. In blocks 1305 and 1306, the component recursively invokes the hash component passing indication of the path and the hashes to generate a calculated hash. The component then invokes a calculate hash component passing the calculated hash and the hash as the first or second parameter depending on the direction to calculate the hash for the parent node and then returns the calculated hash. In decision block 1307, if the direction is left, then the component continues at block 1308, else the component continues at block 1309. In blocks 1308 and 1309, the component invokes the calculate hash function passing the hash and the last hash of the hashes, which represent hashes of leaf nodes, to generate a hash of the parent node of the leaf nodes and then returns the calculated hash.

The following paragraphs describe various embodiments of aspects of the CEG system. An implementation of the CEG system may employ any combination of the embodiments. The processing described below may be performed by a computing device with a processor that executes computer-executable instructions stored on a computer-readable storage medium that implements the CEG system.

In some embodiments, a method performed by a computing system for storing in a blockchain information on balances of accounts, the balances being of a cryptocurrency is provided. For each account, the method retrieves the balance of the account, allocates one or more addresses from a pool of addresses to the account, and generates a hash for a leaf node for the account. The allocated one or more addresses is associated with an amount of the cryptocurrency to cover the retrieved balance. The hash is based on the account, the retrieved balance, and the allocated one or more addresses. The method generates a hash tree from the hashes for the leaf nodes of the account. The hash tree has a root hash. The method records in the blockchain a transaction that identifies the root hash of the hash tree as evidence of the balances and allocation of the addresses to the accounts. In some embodiments, the allocating of addresses includes allocating first from a hot pool and then from a cold pool. In some embodiments, the hash tree is a Merkle tree. In some embodiments, the hash for a leaf node of an account is further based on a nonce generated for the account and further comprising providing the nonce to an owner of the account for use in regenerating the hash for the leaf node. In some embodiments, each leaf node for an account includes the balance for the account and each non-leaf nodes include the sum of the balances of its child nodes. In some embodiments, the method further provides the allocation of the addresses as evidence that the addresses have an amount of cryptocurrency that is sufficient to cover the balances of the account. In some embodiments, the method further records a transaction in the blockchain to transfer a designated amount of cryptocurrency from one of the allocated addresses as evidence of ownership of the address. In some embodiments, designated amount is specified by an organization that does not own the address. In some embodiments, the cryptocurrency is bitcoin.

In some embodiments, a method performed by a computing device for generating an accounting of account balances of a cryptocurrency of accounts from a pool of addresses is provided. Each address has an address balance of the cryptocurrency of a blockchain. For each account, the method retrieves the account balance of the account and repeatedly selects an address whose address balance has not been completely allocated to an account the following and generates a record that includes an indication that the selected address is allocated to the account and an indication of a portion of the address balance of the selected address that is allocated to the account until a total address balance has been allocated to cover the account balance. The method then records in the blockchain a hash generated from the generated records as evidence of the accounts represented by the generated records. In some embodiments, a generated record for an account further includes an indication of a remaining account balance of the account for which a portion of an address balance has not been allocated and of a remaining address balance of the selected address that has not been allocated to an account. In some embodiments, the hash is a root hash of a hash tree generated from a leaf node for each account. In some embodiments, the leaf node for an account includes a hash based on the generated one or more records for the account. In some embodiments, the method further provides the one or more records for an account to an account owner of the account for verification that the recorded hash was based on the one or more records generated for the account. In some embodiments, the recorded hash is a root hash of a hash tree, and the method further provides to the account owner hashes of the hash tree sufficient to generate the root hash from the additional hashes and a hash based on one or more of the records generated for the account. In some embodiments, the recording in the blockchain of the hash includes recording a transaction with an output script that includes the hash. In some embodiments, the transaction inputs an amount of cryptocurrency from a designated address and outputs the amount of the cryptocurrency to the designated address.

In some embodiments, one or more computer-readable storage mediums are provided that store an accounting of an account with an account balance in a cryptocurrency of a blockchain. The accounting includes a record indicating an account identifier of the account, one or more addresses of a pool of addresses that is allocated to the account, and a portion of an address balance of each of the one or more addresses that is allocated to account. The accounting also includes a transaction recorded in the blockchain that stores a hash based on the record. The hash can be regenerated from the record to verify the allocation of the addresses and portions of the account. In some embodiments, the blockchain is a bitcoin blockchain.

In some embodiments, a computing system for storing in a blockchain information on balances of accounts. The balances are of a cryptocurrency. The computing system includes one or more computer-readable storage mediums storing computer-executable instructions and one or more processors for executing the computer-executable instructions stored in the one or more computer-readable storage mediums. The instructions control the computing system to allocate an address from a pool of addresses to an account. The allocated address is associated with an amount of the cryptocurrency to cover an account balance of the account. The instructions control the computing system to generate a hash for a leaf node for an account. The hash is based on the account, the account balance, and the allocated address. The instructions control the computing system to generate a hash tree from the hashes for the leaf nodes of one or more accounts. The hash tree has a root hash. The instructions control the computing system to record in the blockchain a transaction that identifies the root hash of the hash tree as proof of the account balance of the one or more accounts and allocation of the address to the one or more accounts. In some embodiments, the address is allocated from a hot pool of addresses if the account balances of the addresses in the hot pool have not been fully allocated to accounts and from a cold pool of addresses otherwise. In some embodiments, the hash tree is a Merkle tree. In some embodiments, the hash for a leaf node of an account is further based on a nonce generated for the account and further comprising providing the nonce to an owner of the account for use in regenerating the hash for the leaf node. In some embodiments, each leaf node for an account includes the balance for the account and each non-leaf nodes include the sum of the balances of its child nodes.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing system for storing in a blockchain information on balances of accounts, the balances being of a cryptocurrency, the method comprising:
for each account,
retrieving the balance of the account;
allocating one or more addresses from a pool of addresses to the account, the allocated one or more addresses being associated with an amount of the cryptocurrency to cover the retrieved balance; and
generating a hash for a leaf node for the account, the hash being based on the account, the retrieved balance, and the allocated one or more addresses;
generating a hash tree from the hashes for the leaf nodes of the account, the hash tree having a root hash; and
recording in the blockchain a transaction that identifies the root hash of the hash tree as evidence of the balances and allocation of the addresses to the accounts.

2. The method of claim 1 wherein the allocating of addresses includes allocating first from a hot pool and then from a cold pool.

3. The method of claim 1 wherein the hash tree is a Merkle tree.

4. The method of claim 1 wherein the hash for a leaf node of an account is further based on a nonce generated for the account and further comprising providing the nonce to an owner of the account for use in regenerating the hash for the leaf node.

5. The method of claim 1 wherein each leaf node for an account includes the balance for the account and each non-leaf nodes include the sum of the balances of its child nodes.

6. The method of claim 1 further comprising providing the allocation of the addresses as evidence that the addresses have an amount of cryptocurrency that is sufficient to cover the balances of the account.

7. The method of claim 1 further comprising recording a transaction in the blockchain to transfer a designated amount of cryptocurrency from one of the allocated addresses as evidence of ownership of the address.

8. The method of claim 7 wherein the designated amount is specified by an organization that does not own the address.

9. The method of claim 1 wherein the cryptocurrency is bitcoin.

10. A method performed by a computing device for generating an accounting of account balances of a cryptocurrency of accounts from a pool of addresses, each address having an address balance of the cryptocurrency of a blockchain, the method comprising:
for each account,
retrieving the account balance of the account; and
repeating until a total address balance has been allocated to cover the account balance:
selecting an address whose address balance has not been completely allocated to an account; and
generating a record that includes an indication that the selected address is allocated to the account and an indication of a portion of the address balance of the selected address that is allocated to the account; and
recording in the blockchain a hash generated from the generated records as evidence of the accounts represented by the generated records.

11. The method of claim 10 wherein a generated record for an account further includes an indication of a remaining account balance of the account for which a portion of an address balance has not been allocated and of a remaining address balance of the selected address that has not been allocated to an account.

12. The method of claim 10 wherein the hash is a root hash of a hash tree generated from a leaf node for each account.

13. The method of claim 12 wherein the leaf node for an account includes a hash based on the generated one or more records for the account.

14. The method of claim 10 further comprising providing the one or more records for an account to an account owner of the account for verification that the recorded hash was based on the one or more records generated for the account.

15. The method of claim 14 wherein the recorded hash is a root hash of a hash tree and further comprising providing to the account owner hashes of the hash tree sufficient to generate the root hash from the additional hashes and a hash based on one or more of the records generated for the account.

16. The method of claim 10 wherein the recording in the blockchain of the hash includes recording a transaction with an output script that includes the hash.

17. The method of claim 16 wherein the transaction inputs an amount of cryptocurrency from a designated address and outputs the amount of the cryptocurrency to the designated address.

18. One or more computer-readable storage mediums storing an accounting of an account with an account balance in a cryptocurrency of a blockchain, the accounting comprising:
a record indicating an account identifier of the account, one or more addresses of a pool of addresses that is allocated to the account, and a portion of an address balance of each of the one or more addresses that is allocated to account; and
a transaction recorded in the blockchain that stores a hash based on the record wherein the hash can be regenerated from the record to verify the allocation of the addresses and portions of the account.

19. The method of claim 18 wherein the blockchain is a bitcoin blockchain.

20. A computing system for storing in a blockchain information on balances of accounts, the balances being of a cryptocurrency, the computing system comprising:
one or more computer-readable storage mediums storing computer-executable instructions for controlling the computing system to:
for each account,
allocate an address from a pool of addresses to an account, the allocated address being associated with an amount of the cryptocurrency to cover an account balance of the account;
generate a hash for a leaf node for an account, the hash being based on the account, the account balance, and the allocated address;
generate a hash tree from the hashes for the leaf nodes of one or more accounts, the hash tree having a root hash; and
record in the blockchain a transaction that identifies the root hash of the hash tree as proof of the account balance of the one or more accounts and allocation of the address to the one or more accounts; and
one or more processors for executing the computer-executable instructions stored in the one or more computer-readable storage mediums.

21. The computing system of claim 20 wherein the address is allocated from a hot pool of addresses if the account balances of the addresses in the hot pool have not been fully allocated to accounts and from a cold pool of addresses otherwise.

22. The computing system of claim 20 wherein the hash tree is a Merkle tree.

23. The computing system of claim 20 wherein the hash for a leaf node of an account is further based on a nonce generated for the account and further comprising providing the nonce to an owner of the account for use in regenerating the hash for the leaf node.

24. The computing system of claim 20 wherein each leaf node for an account includes the balance for the account and each non-leaf nodes include the sum of the balances of its child nodes.
